(19) United States
(12) Patent Application Publication
(10) Pub. No.: US 2011/0141560 A1
(43) Pub. Date: Jun. 16, 2011

(54) 3-DIMENSIONAL DISPLAY DEVICE

(75) Inventors: Sung Kyu KIM, Seoul (KR); Seon Kyu YOON, Jeju-si (KR); Kwang Hoon LEE, Seoul (KR)

(73) Assignee: Korea Institute of Science and Technology

(21) Appl. No.: 12/963,368

(22) Filed: Dec. 8, 2010

(30) Foreign Application Priority Data
Dec. 10, 2009 (KR) 10-2009-0122697

(51) Int. Cl. G02B 27/22

(52) U.S. Cl. 359/463

(57) ABSTRACT

A 3-Dimensional display device having an optical plate: The 3D display device includes: at least one optical plate wherein the optical plate has a plurality of segments disposed with a predetermined incline and a predetermined interval; and a display panel aligned with the optical plate and that includes pixels, wherein each of the pixels comprises sub-pixels and each of the sub-pixels is disposed with an incline the same as or similar to the predetermined incline.

### CROSS-REFERENCE TO RELATED APPLICATIONS

The present application claims priority from Korean Patent Application No. 10-2009-0122697 filed on Dec. 10, 2009, the entire subject matter of which is incorporated herein by reference.

### TECHNICAL FIELD

The present disclosure relates to a 3-Dimensional display device, and more particularly to a 3-Dimensional display device having an optical plate.

### BACKGROUND

A 3D display device generally uses parallax of the two eyes by dividing an image provided from the display panel into images for the left and right eyes respectively and providing them to a viewer. The 3D display device is generally categorized into two types: non-spectacle type 3D display device; and spectacle type 3D display device. The spectacle type 3D display device requires a viewer to wear special equipment such as polarizing eyeglasses to enjoy 3D images. In contrast, the non-spectacle type 3D display device does not require a viewer to wear any special equipment. The non-spectacle type 3D display device divides an image, which is merged two images including disparities of the objects, into images for left and right eye respectively, by using a 3D optical plate such as a lenticular lens and parallax barrier, which is disposed in front of a display panel. Accordingly, the viewer may enjoy 3D images without any special equipment.

Recently, the non-spectacle type 3-D display, which does not need special glasses, has been developed primarily. The non-spectacle type 3D display typically includes a fusible stereo forming optics such as a parallax barrier or a lenticular lens.

When a parallax barrier or lenticular lens is used, problems such as degradation of vertical and horizontal resolutions and difference among pixels regarding units as R, G and B viewing images may occur.

Crosstalk is a phenomenon in which images of adjacent pixels get mixed. Crosstalk may occur in most 3D image display devices and disturb a viewer from recognizing the 3D images clearly. In other words, crosstalk degrades the quality of 3D images, limits the viewing zone of a pair of stereo image and reduces resolution of 3D images as the number of view points increases.

Crosstalk may occur when the optical plate (parallax barrier or lenticular lens) is vertically disposed.

### SUMMARY

To solve the foregoing drawbacks of previously-known systems, the present invention employs an inclined optical plate that allows for adjustments in the ratio of vertical and horizontal resolutions by using the full width of a unit of an image to be viewed thereby reducing the resolution degradation due to the difference between images.

In one embodiment, by way of non-limiting example, a 3D display device includes at least one optical plate wherein the optical plate has a plurality of segments disposed with a predetermined incline and a predetermined interval, a display panel aligned with the optical plate and that has pixels, wherein each of the pixels comprises sub-pixels and each of the sub-pixels is disposed in the display panel with an incline the same as or similar to the predetermined incline.

In one embodiment, by way of non-limiting example, the predetermined incline is in a range from ±90° to ±180° with respect to the horizontal direction of the display panel.

In another embodiment, by way of non-limiting example, the plurality of segments form a parallax barrier.

In an alternate embodiment, by way of non-limiting example, the optical plate is a lenticular lens.

In yet another embodiment, by way of non-limiting example, a line, which connects centers of the sub-pixels in the longitudinal direction, is parallel to a vertical line.

In another alternate embodiment, by way of non-limiting example, a line, which connects centers of the sub-pixels in the longitudinal direction, is inclined with respect to a vertical line.

### BRIEF DESCRIPTION OF THE DRAWINGS

FIG. 1 is a schematic diagram showing an illustrative embodiment of a 3D display device.

FIG. 2 shows the geometric relationship between an inclined optical plate and pixels of a display panel.

FIG. 3A is an enlarged view of the sub-pixels in FIG. 2.

FIG. 3B shows a graph indicating the intensity distribution of each of the beams emitted from sub-pixels R and G through an opening in a certain distance, i.e., viewing distance.

FIG. 4A shows sub-pixels of a display panel disposed with the same incline as the incline of an inclined optical plate with respect to the horizontal direction according to an embodiment of the present invention.

FIG. 4B is a graph indicating intensity distribution of each of the beams emitted from sub-pixels R and B through an opening in a certain distance, i.e., viewing distance.

FIG. 5 shows a graph comparing the crosstalk region L3 in a 3D display device with inclined sub-pixels and an inclined optical plate according to an embodiment of the present invention, and the crosstalk region L4 in a conventional 3D display device with vertically placed sub-pixels and an inclined optical plate.

FIG. 6 shows a 3D display device including an inclined optical plate and a display panel which comprises sub-pixels disposed with the incline θ₂, wherein θ₂ is the same as or similar to the incline θ₁ of the inclined optical plate with respect to the horizontal direction.

FIG. 7 shows a 3D display device including an inclined optical plate and a display panel which comprises sub-pixels disposed with the incline θ₂, wherein θ₂ is the same as or similar to the incline θ₁ of the inclined optical plate with respect to the horizontal direction.

### DETAILED DESCRIPTION

Detailed descriptions are provided with reference to accompanying drawings. A person with ordinary skill in the art would appreciate that the following descriptions are only illustrative and are not in any way limiting. Other embodiments of the present invention may readily suggest themselves to such skilled persons having the benefit of this disclosure.

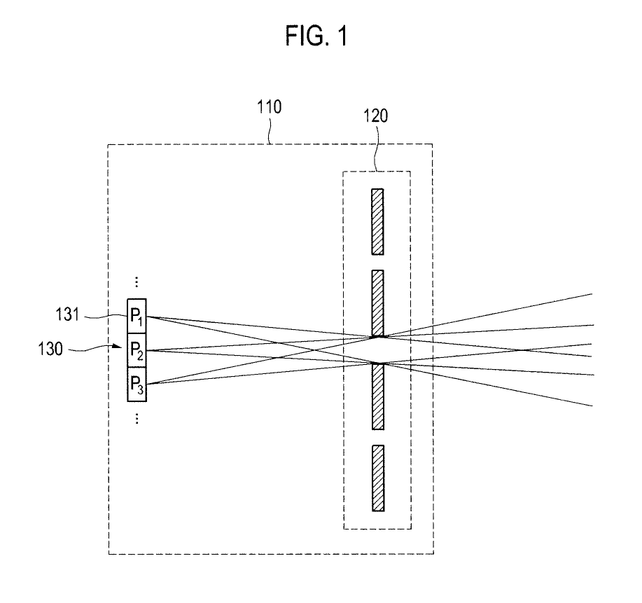

FIG. 1 is a schematic diagram showing an illustrative embodiment of a 3D display device.

In one embodiment, a 3D display device 110 may include a display panel 130 and an optical plate 120. The display panel 130 displays images and the optical plate 120 divides an image into images for left and right eyes respectively to provide 3D images.

In one embodiment, the display panel 130 may have a plurality of pixels 131. Each of the plurality of pixels 131 has sub-pixels R, G and B (not shown). In one embodiment, the display panel 130 may be implemented as an LCD (Liquid Crystal Display), FLCD (Ferro LCD), PDP (Plasma Display Panel), LED (Light Emitting Diode), OLED (Organic LED) and other display devices having pixels that emit light.

In one embodiment, the optical plate 120 may include a plurality of segments which are disposed with a predetermined interval and a predetermined incline with respect to the horizontal or vertical direction. In one embodiment, the plurality of segments of the optical plate 120 may form a parallax barrier or lenticular lens.

In one embodiment, the predetermined incline and the predetermined interval of the optical plate 120 may be adjusted to be suitable for dividing images for left and right eyes respectively, depending on the size of the pixel or sub-pixel of the display panel 130. For example, the horizontal distance between the plurality of segments of the optical plate 120 may be adjusted to be narrower than the horizontal length of the sub-pixel of the display panel 130.

In one embodiment, the predetermined incline of the optical plate 120 may be in a range from ±90° to ±180° with respect to the horizontal direction of the optical plate 120. In one embodiment, the incline of pixels 131 or sub-pixels of the display panel 130 may be the same as the predetermined incline of the optical plate 120. In another embodiment, the incline of pixels 131 or sub-pixels may be similar to the predetermined incline of the optical plate 120. For example, it may be in a range from −20° to 20°, a range from −10° to 10° or a range from −5° to 5° with respect to the predetermined incline of the optical plate 120.

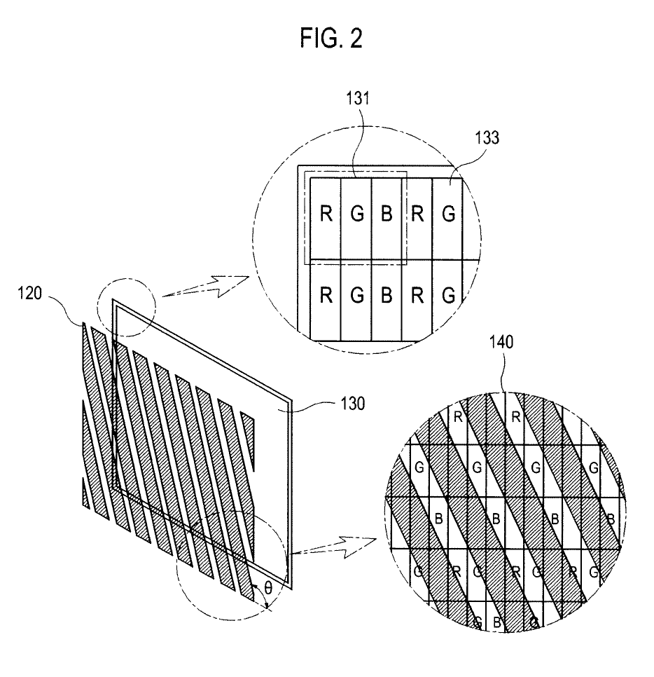

The relationship between the optical plate 120 and the pixels 131 and sub-pixels of the display panel 130 will be described below in more detail with reference to FIGS. 2-7.

FIG. 2 shows the geometric relationship between the inclined optical plate 120 and pixels 131 and 133 of the display panel 130. The inclined optical plate 120 has an incline θ with respect to the horizontal direction of the optical plate 120. The sub-pixels 140 of the display panel 130 are viewed through the openings of the display panel 130.

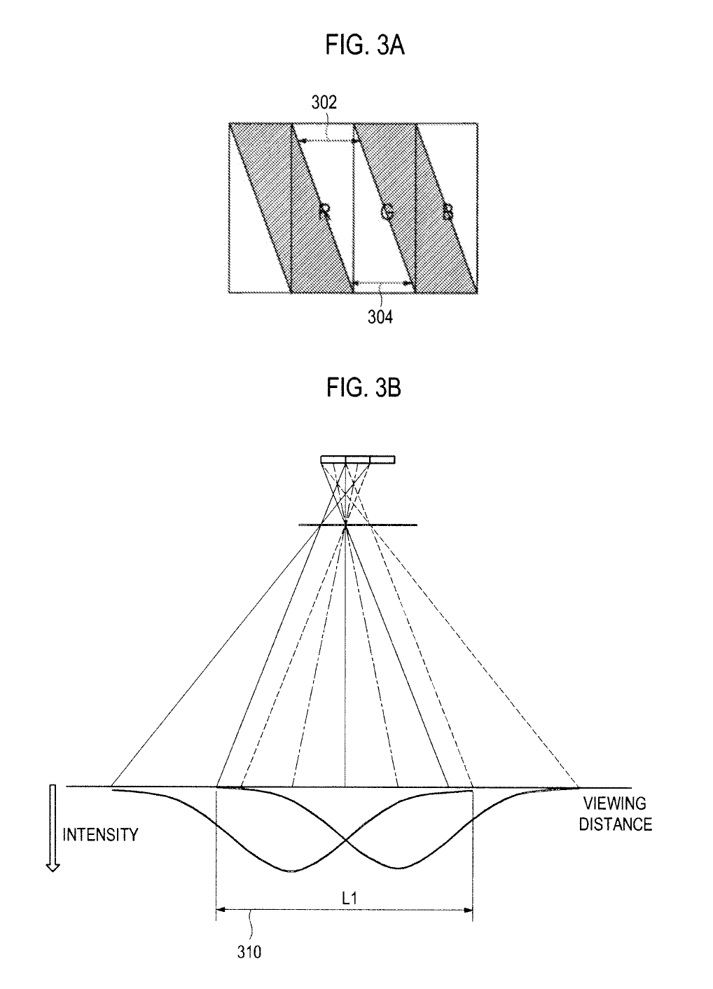

FIG. 3A is an enlarged view of the sub-pixels 140 of the display panel 130 in FIG. 2. FIG. 3B shows a graph indicating the intensity distribution of each of the beams emitted from sub-pixels R and G through an opening in a certain distance, i.e., view distance. Since the optical plate 120 is a view distance away from the display panel 130, not only the beam from the sub-pixel viewed through the opening but also the beam from adjacent sub-pixels may be transmitted. However, the beam from the sub-pixel R has more influence in the upper part 302 of the opening, while the beam from the sub-pixel G has more influence in the lower part 304 of the opening. Crosstalk occurs in the area 310 where the two beams overlap.

As described above, since crosstalk occurs when images of adjacent pixels are mixed, increased influence of the beams emitted from adjacent pixels through the opening of the optical plate 120 can result in increased crosstalk. Thus, a 3D display device with an inclined optical plate may suffer more crosstalk than a 3D display device with a vertically placed optical plate.

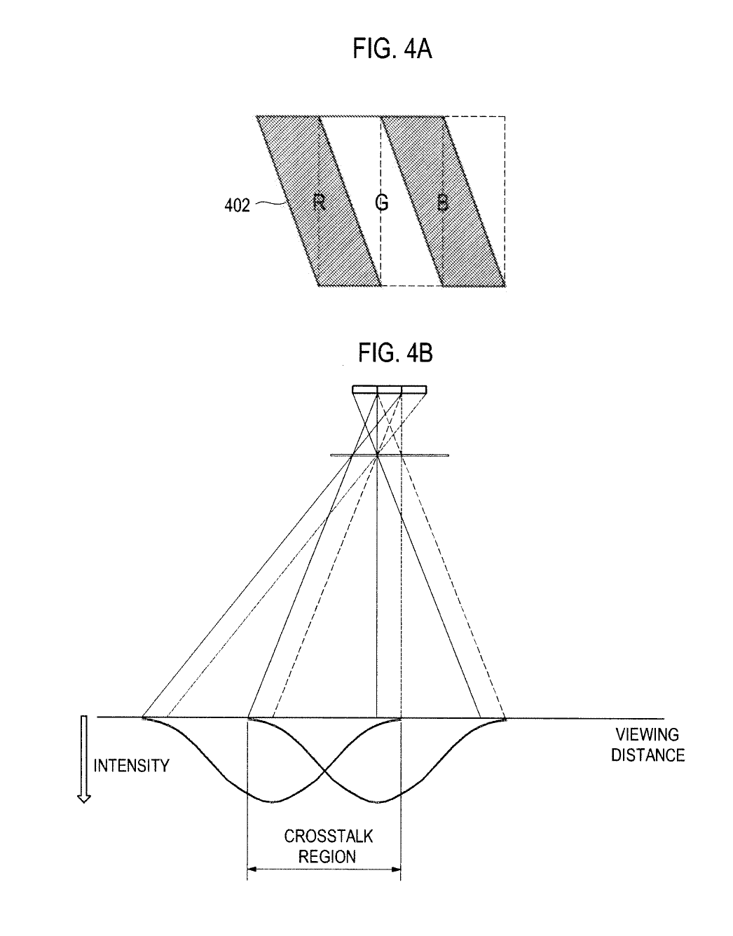

FIG. 4A shows a sub-pixel 402 of a display panel 130 disposed with the same incline as the incline of an inclined optical plate with respect to the horizontal direction according to an embodiment of the present invention. FIG. 4B is a graph indicating intensity distribution of each of the beams emitted from sub-pixels R and B through an opening in a certain distance, i.e., view distance. When the sub-pixel 402 is placed as shown in FIG. 4A, the influence of the beam emitted from adjacent sub-pixels through the opening of the inclined optical plate is substantially the same as the influence of the beam emitted from adjacent sub-pixels through the opening of the vertically placed optical plate. Thus, the crosstalk in a 3D display device with inclined sub-pixels and an inclined optical plate may be reduced to the same level as in a 3D display device with vertically placed sub-pixels and a vertically placed optical plate.

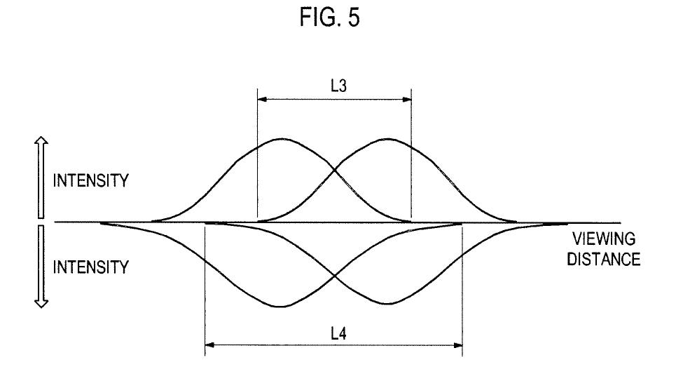

FIG. 5 shows a graph comparing the crosstalk region L3 in a 3D display device with inclined sub-pixels and an inclined optical plate according to an embodiment of the present invention, and the crosstalk region L4 in a conventional 3D display device with vertically placed sub-pixels and an inclined placed optical plate. It shows that the embodiment of the present invention has the smaller crosstalk region and the weaker beam intensity.

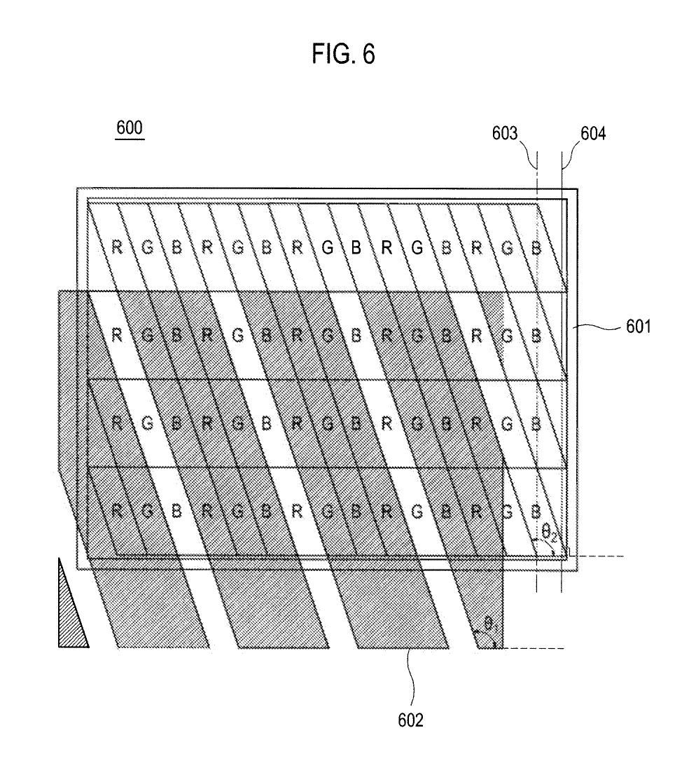

FIG. 6 shows a 3D display device 600 having an inclined optical plate 602 and a display panel 601 which comprises sub-pixels disposed with an incline θ₂, wherein θ₂ is the same as or similar to the incline θ₁ of the inclined optical plate 602 with respect to the horizontal direction. As shown in FIG. 6, the horizontal distance between the segments of the optical plate 602 corresponds to the horizontal length of one sub-pixel. Thus, crosstalk in the 3-D display device 600 may be reduced to the same level as in the 3D display device with a vertically placed optical plate.

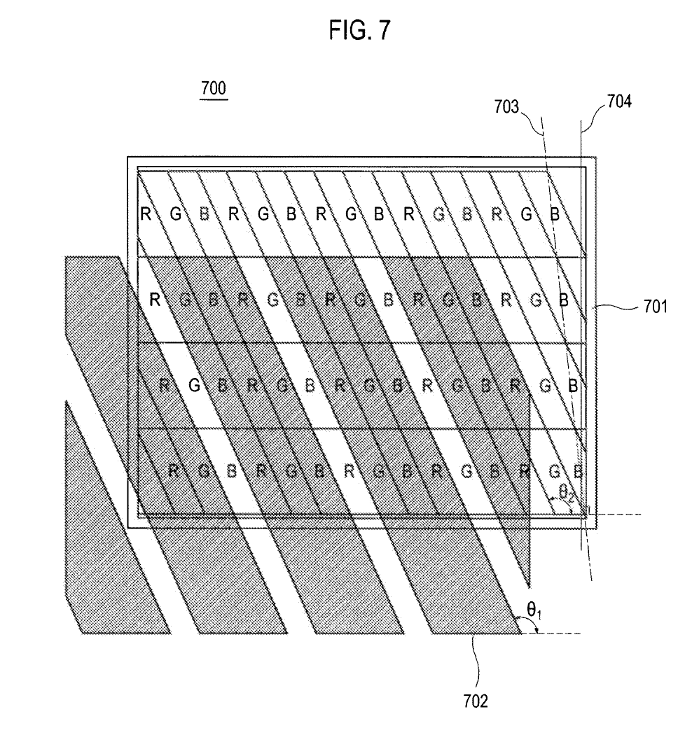

FIG. 7 shows a 3D display device 700 having an inclined optical plate 702 and a display panel 701 which has sub-pixels disposed with an incline θ₂, wherein θ₂ is the same as or similar to the incline θ₁ of the inclined optical plate 702 with respect to the horizontal direction. As shown in FIG. 7, the line 703, which connects centers of the sub-pixels in the longitudinal direction, is inclined with respect to the vertical line 704. When a sub-pixel is disposed with the incline θ₂, wherein θ₂ is the same as or similar to the incline θ₁ of the inclined optical plate 702 with respect to the horizontal direction, the cross-talk in the 3-D display device 700 may be reduced to the same level as in the 3D display device with a vertically placed optical plate.

The descriptions of the present invention have been presented for purposes of illustration, but are not intended to be exhaustive or limited to the invention in the form disclosed. Many modifications and variations will be apparent to those of ordinary skill in the art without departing from the scope and spirit of the invention. The embodiment was chosen and described in order to clearly explain the principles of the invention and the practical application, and to enable those of ordinary skill in the art to understand the invention for various embodiments with various modifications as are suited to the particular use contemplated.

What is claimed is:

1. A 3D display device comprising:
at least one optical plate wherein the optical plate comprises a plurality of segments disposed with a predetermined incline and a predetermined interval; and
a display panel aligned with the optical plate and comprising pixels, wherein each of the pixels comprises sub-pixels and each of the sub-pixels is disposed with an incline the same as or similar to the predetermined incline.

2. The 3D display device of claim 1, wherein the predetermined incline is in a range from ±90° to ±180° with respect to a horizontal direction.

3. The 3D display device of claim 1, wherein the plurality of segments form a parallax barrier.

4. The 3D display device of claim 1, wherein the optical plate is a lenticular lens.

5. The 3D display device of claim 1, wherein a line which connects centers of the sub-pixels in a longitudinal direction, is parallel to a vertical line.

6. The 3D display device of claim 1, wherein a line which connects centers of the sub-pixels in a longitudinal direction, is inclined with respect to a vertical line.
